(19) United States
(12) Patent Application Publication
(10) Pub. No.: US 2017/0180299 A1
(43) Pub. Date: Jun. 22, 2017

(54) System and Method for Expanded Messaging Indicator

(71) Applicant: Facebook, Inc., Menlo Park, CA (US)

(72) Inventor: Eugenio Padilla Garza, San Francisco, CA (US)

(21) Appl. No.: 14/971,964

(22) Filed: Dec. 16, 2015

(51) Int. Cl. H04L 12/58

(52) U.S. Cl. CPC H04L 51/32; H04L 51/10; H04L 51/24

(57) ABSTRACT

In one embodiment, a method includes, by a client computing device of a first user, providing a user interface for presentation. The client computing device may receive data associated with an action in progress on a client computing device of second user. The data may indicate that a message is being composed or seen using the client computing device of the second user. The client computing device of the first user may automatically present an indicator on the user interface based on the received data.

### TECHNICAL FIELD

This disclosure generally relates to notifications and user interfaces.

### BACKGROUND

A social-networking system, which may include a social-networking website, may enable its users (such as persons or organizations) to interact with it and with each other through it. The social-networking system may, with input from a user, create and store in the social-networking system a user profile associated with the user. The user profile may include demographic information, communication-channel information, and information on personal interests of the user. The social-networking system may also, with input from a user, create and store a record of relationships of the user with other users of the social-networking system, as well as provide services (e.g., wall posts, photo-sharing, event organization, messaging, games, or advertisements) to facilitate social interaction between or among users.

The social-networking system may send over one or more networks content or messages related to its services to a mobile or other computing device of a user. A user may also install software applications on a mobile or other computing device of the user for accessing a user profile of the user and other data within the social-networking system. The social-networking system may generate a personalized set of content objects to display to a user, such as a newsfeed of aggregated stories of other users connected to the user.

A mobile computing device—such as a smartphone, tablet computer, or laptop computer—may include functionality for determining its location, direction, or orientation, such as a GPS receiver, compass, gyroscope, or accelerometer. Such a device may also include functionality for wireless communication, such as BLUETOOTH communication, near-field communication (NFC), or infrared (IR) communication or communication with a wireless local area networks (WLANs) or cellular-telephone network. Such a device may also include one or more cameras, scanners, touchscreens, microphones, or speakers. Mobile computing devices may also execute software applications, such as games, web browsers, or social-networking applications. With social-networking applications, users may connect, communicate, and share information with other users in their social networks.

### SUMMARY OF PARTICULAR EMBODIMENTS

In particular embodiments, a client computing device of a user presents a user interface. The client computing device may receive data associated with an action in progress on a client computing device of a second user. The data may indicate that a message is being composed or seen using the client computing device of the second user. The client computing device of the first user may automatically present an indicator on the user interface based on the received data.

The action in progress on the client computing device of the second user may be any one of typing a text message, reading a message sent by the first user, taking a photo, or creating a video or audio message. The data may indicate that a message is being composed, seen, or read based on the actions in progress, such as, for example, data indicating that the second user is composing a photo message or a video message. The indicator automatically presented to the first user on the user interface may describe the type of message that is being composed or may describe the second user's interaction with a message from the client computing device of the first user.

The embodiments disclosed above are only examples, and the scope of this disclosure is not limited to them. Particular embodiments may include all, some, or none of the components, elements, features, functions, operations, or steps of the embodiments disclosed above. Embodiments according to the invention are in particular disclosed in the attached claims directed to a method, a storage medium, a system and a computer program product, wherein any feature mentioned in one claim category, e.g. method, can be claimed in another claim category, e.g. system, as well. The dependencies or references back in the attached claims are chosen for formal reasons only. However any subject matter resulting from a deliberate reference back to any previous claims (in particular multiple dependencies) can be claimed as well, so that any combination of claims and the features thereof are disclosed and can be claimed regardless of the dependencies chosen in the attached claims. The subject-matter which can be claimed comprises not only the combinations of features as set out in the attached claims but also any other combination of features in the claims, wherein each feature mentioned in the claims can be combined with any other feature or combination of other features in the claims. Furthermore, any of the embodiments and features described or depicted herein can be claimed in a separate claim and/or in any combination with any embodiment or feature described or depicted herein or with any of the features of the attached claims.

### BRIEF DESCRIPTION OF THE DRAWINGS

FIG. 1 illustrates an example network environment associated with a social-networking system.

FIG. 2 illustrates an example social graph.

FIGS. 3A-3C illustrate an example messaging inbox user interface with example messaging indicators for messages being composed.

FIGS. 4A and 4B illustrate an example messaging inbox user interface with example messaging indicators for messages being read.

FIGS. 5A and 5B illustrate an example texting user interface with an example voice message indicator.

FIG. 6 illustrates an example group text interface with an example status indicator.

FIG. 7 illustrates example message indicators for application in the foreground and background.

FIG. 8 illustrates an example method for presenting expanded messaging indicators.

FIG. 9 illustrates an example computer system.

### DESCRIPTION OF EXAMPLE EMBODIMENTS

A user interface (UI) may be incorporated into any type of software application, including, for example, a desktop application, mobile application, or web-based application, to enable users to interact with and control the application. A graphical user interface (GUI) is a type of user interface that enables users to interact with software applications through multi-media objects, including, for example, icons, buttons, menus, images, video, or audios. A UI or GUI may provide indicators to a user relating to messages sent by the user or messages that the user is about to receive. These indicators may appear in a messaging or social networking UI or GUI, or they may appear as push notifications in different kinds of UI. The indicators may be icons or short text descriptions that describe a messaging action in progress, such as whether another user is typing a message or recording a video message.

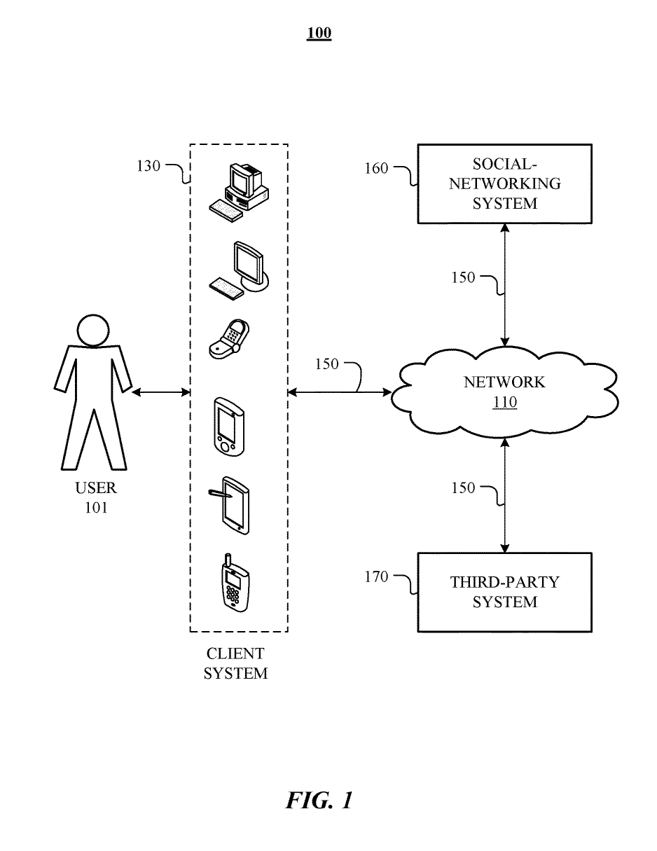

In particular embodiments, a software application may be associated with a social-networking system. FIG. 1 illustrates an example network environment 100 associated with a social-networking system. Network environment 100 includes a user 101, a client system 130, a social-networking system 160, and a third-party system 170 connected to each other by a network 110. Although FIG. 1 illustrates a particular arrangement of user 101, client system 130, social-networking system 160, third-party system 170, and network 110, this disclosure contemplates any suitable arrangement of user 101, client system 130, social-networking system 160, third-party system 170, and network 110. As an example and not by way of limitation, two or more of client system 130, social-networking system 160, and third-party system 170 may be connected to each other directly, bypassing network 110. As another example, two or more of client system 130, social-networking system 160, and third-party system 170 may be physically or logically co-located with each other in whole or in part. Moreover, although FIG. 1 illustrates a particular number of users 101, client systems 130, social-networking systems 160, third-party systems 170, and networks 110, this disclosure contemplates any suitable number of users 101, client systems 130, social-networking systems 160, third-party systems 170, and networks 110. As an example and not by way of limitation, network environment 100 may include multiple users 101, client systems 130, social-networking systems 160, third-party systems 170, and networks 110.

In particular embodiments, user 101 may be an individual (human user), an entity (e.g., an enterprise, business, or third-party application), or a group (e.g., of individuals or entities) that interacts or communicates with or over social-networking system 160. In particular embodiments, social-networking system 160 may be a network-addressable computing system hosting an online social network. Social-networking system 160 may generate, store, receive, and send social-networking data, such as, for example, user-profile data, concept-profile data, social-graph information, or other suitable data related to the online social network. Social-networking system 160 may be accessed by the other components of network environment 100 either directly or via network 110. In particular embodiments, social-networking system 160 may include an authorization server (or other suitable component(s)) that allows users 101 to opt in to or opt out of having their actions logged by social-networking system 160 or shared with other systems (e.g., third-party systems 170), for example, by setting appropriate privacy settings. In particular embodiments, third-party system 170 may be a network-addressable computing system that can host various third-party software applications (e.g., web-based applications). Third-party system 170 may generate, store, receive, and transmit various types of data, such as, for example, texts, images, videos, or audios. Third-party system 170 may be accessed by the other components of network environment 100 either directly or via network 110. In particular embodiments, one or more users 101 may use one or more client systems 130 to access, send data to, and receive data from social-networking system 160 or third-party system 170. Client system 130 may access social-networking system 160 or third-party system 170 directly, via network 110, or via a third-party system. As an example and not by way of limitation, client system 130 may access third-party system 170 via social-networking system 160. Client system 130 may be any suitable client computing device, such as, for example, a personal computer, a laptop computer, a cellular telephone, a smartphone, a television, or a tablet computer. Third-party system 170 may generate, store, receive, and transmit various types of data, such as, for example, texts, images, videos, audios, or other data related to messages sent between users, including data describing the interaction of a message before and after transmission of the message. Third-party system 170 may be accessed by the other components of network environment 100 either directly or via network 110. In particular embodiments, one or more users 101 may use one or more client systems 130 to access, send data to, and receive data from social-networking system 160 or third-party system 170. Client system 130 may access social-networking system 160 or third-party system 170 directly, via network 110, or via a third-party system. As an example and not by way of limitation, client system 130 may access third-party system 170 via social-networking system 160. Client system 130 may be any suitable client computing device, such as, for example, a personal computer, a laptop computer, a cellular telephone, a smartphone, a tablet computer, or an augmented/virtual reality device

A privacy setting of a user may determine what information associated with the user may be logged, how information associated with the user may be logged, when information associated with the user may be logged, who may log information associated with the user, whom information associated with the user may be shared with, and for what purposes information associated with the user may be logged or shared. Authorization servers may be used to enforce one or more privacy settings of the users of social-networking system 30 through blocking, data hashing, anonymization, or other suitable techniques as appropriate. Privacy settings may further determine how messaging metadata is logged, for example, whether data about a type of message being composed or data about a video message being watched is logged with social-networking system 160 and whether the data is shared with another user.

This disclosure contemplates any suitable network 110. As an example and not by way of limitation, one or more portions of network 110 may include an ad hoc network, an intranet, an extranet, a virtual private network (VPN), a local area network (LAN), a wireless LAN (WLAN), a wide area network (WAN), a wireless WAN (WWAN), a metropolitan area network (MAN), a portion of the Internet, a portion of the Public Switched Telephone Network (PSTN), a cellular telephone network, or a combination of two or more of these. Network 110 may include one or more networks 110.

Links 150 may connect client system 130, social-networking system 160, and third-party system 170 to communication network 110 or to each other. This disclosure contemplates any suitable links 150. In particular embodiments, one or more links 150 include one or more wireline (such as for example Digital Subscriber Line (DSL) or Data Over Cable Service Interface Specification (DOC SIS)), wireless (such as for example Wi-Fi or Worldwide Interoperability for Microwave Access (WiMAX)), or optical (such as for example Synchronous Optical Network (SONET) or Synchronous Digital Hierarchy (SDH)) links. In particular embodiments, one or more links 150 each include an ad hoc network, an intranet, an extranet, a VPN, a LAN, a WLAN, a WAN, a WWAN, a MAN, a portion of the Internet, a portion of the PSTN, a cellular technology-based network, a satellite communications technology-based network, another link 150, or a combination of two or more such links 150. Links 150 need not necessarily be the same throughout network environment 100. One or more first links 150 may differ in one or more respects from one or more second links 150.

In particular embodiments, data (e.g., data representing various types of information or content) may be sent between servers associated with social-networking system 160 and individual client systems 130 via network 110. When two electronic devices (e.g., a server and a client) are connected to a network (e.g., a computer or communications network, such as network 110), data may be transmitted between the two devices over the network using one or more suitable network protocols. A network may include any number of sub-networks. By transmitting data between the two devices, the two devices may communicate with each other.

In network communications, there are two ways to send a communication (i.e., data) from one device to another device: push and pull. With push technology, the request for the communication transaction is initiated by the sending device. That is, the sending device “pushes” the communication, so to speak, to the receiving device. In this case, the sending device may be considered the active party and the receiving device may be considered the passive party in the transaction. In contrast, with pull technology, the request for the communication transaction is initiated by the receiving device. That is, the receiving device “pulls” the communication, so to speak, from the sending device. In this case, the sending device may be considered the passive party and the receiving device may be considered the active party in the transaction. In particular embodiments, a server associated with social-networking system 160 may push data to a client system 130. A communication pushed from a server to a client may be referred to as a “push notification”. The push notification may appear or be presented on a user interface of the client. Similarly, a client system 130 may push data to a server associated with social-networking system 160.

In particular embodiments, a client system 130 may be a mobile electronic or computing device. A mobile electronic device—such as a Smartphone, tablet computer, or laptop computer—may include functionality for determining its location, direction, or orientation, such as a GPS receiver, compass, or gyroscope. Such a mobile device may also include functionality for wireless communication, such as BLUETOOTH communication, near-field communication (NFC), or infrared (IR) communication or communication with wireless local area networks (WLANs) or cellular-telephone network. Such a mobile device may also include one or more cameras, scanners, touch screens, microphones, or speakers. Mobile electronic devices may also execute software applications, such as games, web browsers, or social-networking applications.

With social-networking applications, users may connect, communicate, and share information with other users in their social networks. Social-networking applications may include messaging applications, message board applications, news-feed applications, or a combination of applications providing messaging and news feed functions. Messages or content may be sent between users 101 on one or more client systems 130. Messages or content from a first user may be transmitted, via network 110 to third-party system 170, and third-party system 170 may transmit the message or content to one or more intended recipients, based on privacy settings of the users sending or receiving the message or content. Messages or content may include news feed posts to a specific social group or network, private messages between two users, messages shared in a group messaging application, or public posts on a message board.

In addition to the actual content and messages sent between users, other data or metadata related to messages or content being created by users may provide information on an action in progress. Actions in progress may be actions performed by users before sending a message or actions performed after a message or content has been sent and is being consumed by users 101. For example, actions in progress related to composing or creating a message prior to transmitting it to third-party system 170 (which may then be transmitted to intended recipients) may include typing a message, taking a photo, or creating a video or audio message. Data associated with these actions in progress may depend on the action itself. For example, data associated with typing a text message may include a rate of typing, whether a user is typing on a smartphone or desktop keyboard, whether a user has drafted a message but not yet completed it, or a length of the message as it is being composed. In another example, data associated with creating a video message may include how long the user is recording video. Data associated with actions in progress related to reading, consuming, or seeing a message (e.g., after a message has been transmitted) may include the time that a chat message has been read, the time that a video message has been read, or how many times a user has re-played an audio message. Data associated with actions in progress are not limited to actions within a specific conversation or within the same application. Actions in progress may further include user actions performed in different applications or conversation threads, such as researching a topic in a web browser, looking up a music video, or participating in a different message board or chat window.

Expanded messaging indicators provided to users may describe these actions in progress and may contribute to a more dynamic, contextual, and interactive experience to sending and receiving messages between users. For example, instead of a typical messaging experience where a user sends a message and waits for replies, the user may be able to gauge or experience the reactions of other users in real-time based on expanded messaging indicators. An indicator describing a faster rate of typing a reply message from a sender may give the recipient of the reply a sense of urgency or a greater emotional response, depending on the context of the messages sent and received.

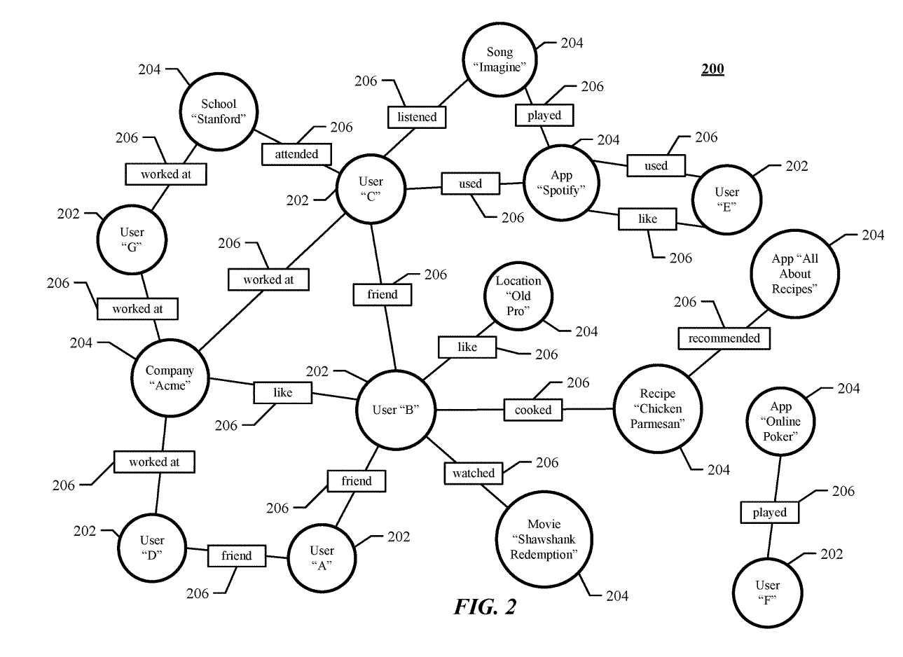

FIG. 2 illustrates example social graph 200. In particular embodiments, social-networking system 160 may store one or more social graphs 200 in one or more data stores. In particular embodiments, social graph 200 may include multiple nodes—which may include multiple user nodes 202 or multiple concept nodes 204—and multiple edges 206 connecting the nodes. Example social graph 200 illustrated in FIG. 2 is shown, for didactic purposes, in a two-dimensional visual map representation. In particular embodiments, a social-networking system 160, client system 130, or third-party system 170 may access social graph 200 and related social-graph information for suitable applications. The nodes and edges of social graph 200 may be stored as data objects, for example, in a data store (such as a social-graph database). Such a data store may include one or more searchable or queryable indexes of nodes or edges of social graph 200.

In particular embodiments, a user node 202 may correspond to a user of social-networking system 160. As an example and not by way of limitation, a user may be an individual (human user), an entity (e.g., an enterprise, business, or third-party application), or a group (e.g., of individuals or entities) that interacts or communicates with or over social-networking system 160. In particular embodiments, when a user registers for an account with social-networking system 160, social-networking system 160 may create a user node 202 corresponding to the user, and store the user node 202 in one or more data stores. Users and user nodes 202 described herein may, where appropriate, refer to registered users and user nodes 202 associated with registered users. In addition or as an alternative, users and user nodes 202 described herein may, where appropriate, refer to users that have not registered with social-networking system 160. In particular embodiments, a user node 202 may be associated with information provided by a user or information gathered by various systems, including social-networking system 160. As an example and not by way of limitation, a user may provide his or her name, profile picture, contact information, birth date, sex, marital status, family status, employment, education background, preferences, interests, or other demographic information. In particular embodiments, a user node 202 may be associated with one or more data objects corresponding to information associated with a user. In particular embodiments, a user node 202 may correspond to one or more webpages.

In particular embodiments, a concept node 204 may correspond to a concept. As an example and not by way of limitation, a concept may correspond to a place (such as, for example, a movie theater, restaurant, landmark, or city); a website (such as, for example, a website associated with social-network system 160 or a third-party website associated with a web-application server); an entity (such as, for example, a person, business, group, sports team, or celebrity); a resource (such as, for example, an audio file, video file, digital photo, text file, structured document, or application) which may be located within social-networking system 160 or on an external server, such as a web-application server; real or intellectual property (such as, for example, a sculpture, painting, movie, game, song, idea, photograph, or written work); a game; an activity; an idea or theory; an object in a augmented/virtual reality environment; another suitable concept; or two or more such concepts. A concept node 204 may be associated with information of a concept provided by a user or information gathered by various systems, including social-networking system 160. As an example and not by way of limitation, information of a concept may include a name or a title; one or more images (e.g., an image of the cover page of a book); a location (e.g., an address or a geographical location); a website (which may be associated with a URL); contact information (e.g., a phone number or an email address); other suitable concept information; or any suitable combination of such information. In particular embodiments, a concept node 204 may be associated with one or more data objects corresponding to information associated with concept node 204. In particular embodiments, a concept node 204 may correspond to one or more webpages.

In particular embodiments, a node in social graph 200 may represent or be represented by a webpage (which may be referred to as a “profile page”). Profile pages may be hosted by or accessible to social-networking system 160. Profile pages may also be hosted on third-party websites associated with a third-party server 170. As an example and not by way of limitation, a profile page corresponding to a particular external webpage may be the particular external webpage and the profile page may correspond to a particular concept node 204. Profile pages may be viewable by all or a selected subset of other users. As an example and not by way of limitation, a user node 202 may have a corresponding user-profile page in which the corresponding user may add content, make declarations, or otherwise express himself or herself. As another example and not by way of limitation, a concept node 204 may have a corresponding concept-profile page in which one or more users may add content, make declarations, or express themselves, particularly in relation to the concept corresponding to concept node 204.

In particular embodiments, a concept node 204 may represent a third-party webpage or resource hosted by a third-party system 170. The third-party webpage or resource may include, among other elements, content, a selectable or other icon, or other inter-actable object (which may be implemented, for example, in JavaScript, AJAX, or PHP codes) representing an action or activity. As an example and not by way of limitation, a third-party webpage may include a selectable icon such as “like,” “check-in,” “eat,” “recommend,” or another suitable action or activity. A user viewing the third-party webpage may perform an action by selecting one of the icons (e.g., “check-in”), causing a client system 130 to send to social-networking system 160 a message indicating the user's action. In response to the message, social-networking system 160 may create an edge (e.g., a check-in-type edge) between a user node 202 corresponding to the user and a concept node 204 corresponding to the third-party webpage or resource and store edge 206 in one or more data stores.

In particular embodiments, a pair of nodes in social graph 200 may be connected to each other by one or more edges 206. An edge 206 connecting a pair of nodes may represent a relationship between the pair of nodes. In particular embodiments, an edge 206 may include or represent one or more data objects or attributes corresponding to the relationship between a pair of nodes. As an example and not by way of limitation, a first user may indicate that a second user is a “friend” of the first user. In response to this indication, social-networking system 160 may send a “friend request” to the second user. If the second user confirms the “friend request,” social-networking system 160 may create an edge 206 connecting the first user's user node 202 to the second user's user node 202 in social graph 200 and store edge 206 as social-graph information in one or more of data stores 164. In the example of FIG. 2, social graph 200 includes an edge 206 indicating a friend relation between user nodes 202 of user “A” and user “B” and an edge indicating a friend relation between user nodes 202 of user “C” and user “B.”Although this disclosure describes or illustrates particular edges 206 with particular attributes connecting particular user nodes 202, this disclosure contemplates any suitable edges 206 with any suitable attributes connecting user nodes 202. As an example and not by way of limitation, an edge 206 may represent a friendship, family relationship, business or employment relationship, fan relationship (including, e.g., liking, etc.), follower relationship, visitor relationship (including, e.g., accessing, viewing, checking-in, sharing, etc.), subscriber relationship, superior/subordinate relationship, reciprocal relationship, non-reciprocal relationship, another suitable type of relationship, or two or more such relationships. Moreover, although this disclosure generally describes nodes as being connected, this disclosure also describes users or concepts as being connected. Herein, references to users or concepts being connected may, where appropriate, refer to the nodes corresponding to those users or concepts being connected in social graph 200 by one or more edges 206.

In particular embodiments, an edge 206 between a user node 202 and a concept node 204 may represent a particular action or activity performed by a user associated with user node 202 toward a concept associated with a concept node 204. As an example and not by way of limitation, as illustrated in FIG. 2, a user may “like,” “attended,” “played,” “listened,” “cooked,” “worked at,” or “watched” a concept, each of which may correspond to a edge type or subtype. A concept-profile page corresponding to a concept node 204 may include, for example, a selectable “check in” icon (such as, for example, a clickable “check in” icon) or a selectable “add to favorites” icon. Similarly, after a user clicks these icons, social-networking system 160 may create a “favorite” edge or a “check in” edge in response to a user's action corresponding to a respective action. As another example and not by way of limitation, a user (user “C”) may listen to a particular song (“Imagine”) using a particular application (SPOTIFY, which is an online music application). In this case, social-networking system 160 may create a “listened” edge 206 and a “used” edge (as illustrated in FIG. 2) between user nodes 202 corresponding to the user and concept nodes 204 corresponding to the song and application to indicate that the user listened to the song and used the application. Moreover, social-networking system 160 may create a “played” edge 206 (as illustrated in FIG. 2) between concept nodes 204 corresponding to the song and the application to indicate that the particular song was played by the particular application. In this case, “played” edge 206 corresponds to an action performed by an external application (SPOTIFY) on an external audio file (the song “Imagine”). Although this disclosure describes particular edges 206 with particular attributes connecting user nodes 202 and concept nodes 204, this disclosure contemplates any suitable edges 206 with any suitable attributes connecting user nodes 202 and concept nodes 204. Moreover, although this disclosure describes edges between a user node 202 and a concept node 204 representing a single relationship, this disclosure contemplates edges between a user node 202 and a concept node 204 representing one or more relationships. As an example and not by way of limitation, an edge 206 may represent both that a user likes and has used at a particular concept. Alternatively, another edge 206 may represent each type of relationship (or multiples of a single relationship) between a user node 202 and a concept node 204 (as illustrated in FIG. 2 between user node 202 for user “E” and concept node 204 for “SPOTIFY”).

In particular embodiments, social-networking system 160 may create an edge 206 between a user node 202 and a concept node 204 in social graph 200. As an example and not by way of limitation, a user viewing a concept-profile page (such as, for example, by using a web browser or a special-purpose application hosted by the user's client system 130) may indicate that he or she likes the concept represented by the concept node 204 by clicking or selecting a “Like” icon, which may cause the user's client system 130 to send to social-networking system 160 a message indicating the user's liking of the concept associated with the concept-profile page. In response to the message, social-networking system 160 may create an edge 206 between user node 202 associated with the user and concept node 204, as illustrated by “like” edge 206 between the user and concept node 204. In particular embodiments, social-networking system 160 may store an edge 206 in one or more data stores. In particular embodiments, an edge 206 may be automatically formed by social-networking system 160 in response to a particular user action. As an example and not by way of limitation, if a first user uploads a picture, watches a movie, or listens to a song, an edge 206 may be formed between user node 202 corresponding to the first user and concept nodes 204 corresponding to those concepts. Although this disclosure describes forming particular edges 206 in particular manners, this disclosure contemplates forming any suitable edges 206 in any suitable manner.

In particular embodiments, social-networking system 160 may determine the social-graph affinity (which may be referred to herein as “affinity”) of various social-graph entities for each other. Affinity may represent the strength of a relationship or level of interest between particular objects associated with the online social network, such as users, concepts, content, actions, advertisements, other objects associated with the online social network, or any suitable combination thereof. Affinity may also be determined with respect to objects associated with third-party systems 170 or other suitable systems. An overall affinity for a social-graph entity for each user, subject matter, or type of content may be established. The overall affinity may change based on continued monitoring of the actions or relationships associated with the social-graph entity. Although this disclosure describes determining particular affinities in a particular manner, this disclosure contemplates determining any suitable affinities in any suitable manner.

In particular embodiments, social-networking system 160 may measure or quantify social-graph affinity using an affinity coefficient (which may be referred to herein as “coefficient”). The coefficient may represent or quantify the strength of a relationship between particular objects associated with the online social network. The coefficient may also represent a probability or function that measures a predicted probability that a user will perform a particular action based on the user's interest in the action. In this way, a user's future actions may be predicted based on the user's prior actions, where the coefficient may be calculated at least in part a the history of the user's actions. Coefficients may be used to predict any number of actions, which may be within or outside of the online social network. As an example and not by way of limitation, these actions may include various types of communications, such as sending messages, posting content, or commenting on content; various types of a observation actions, such as accessing or viewing profile pages, media, or other suitable content; various types of coincidence information about two or more social-graph entities, such as being in the same group, tagged in the same photograph, checked-in at the same location, or attending the same event; or other suitable actions. Although this disclosure describes measuring affinity in a particular manner, this disclosure contemplates measuring affinity in any suitable manner.

In particular embodiments, social-networking system 160 may use a variety of factors to calculate a coefficient. These factors may include, for example, user actions, types of relationships between objects, location information, other suitable factors, or any combination thereof. In particular embodiments, different factors may be weighted differently when calculating the coefficient. The weights for each factor may be static or the weights may change according to, for example, the user, the type of relationship, the type of action, the user's location, and so forth. Ratings for the factors may be combined according to their weights to determine an overall coefficient for the user. As an example and not by way of limitation, particular user actions may be assigned both a rating and a weight while a relationship associated with the particular user action is assigned a rating and a correlating weight (e.g., so the weights total 100%). To calculate the coefficient of a user towards a particular object, the rating assigned to the user's actions may comprise, for example, 60% of the overall coefficient, while the relationship between the user and the object may comprise 40% of the overall coefficient. In particular embodiments, the social-networking system 160 may consider a variety of variables when determining weights for various factors used to calculate a coefficient, such as, for example, the time since information was accessed, decay factors, frequency of access, relationship to information or relationship to the object about which information was accessed, relationship to social-graph entities connected to the object, short- or long-term averages of user actions, user feedback, other suitable variables, or any combination thereof. As an example and not by way of limitation, a coefficient may include a decay factor that causes the strength of the signal provided by particular actions to decay with time, such that more recent actions are more relevant when calculating the coefficient. The ratings and weights may be continuously updated based on continued tracking of the actions upon which the coefficient is based. Any type of process or algorithm may be employed for assigning, combining, averaging, and so forth the ratings for each factor and the weights assigned to the factors. In particular embodiments, social-networking system 160 may determine coefficients using machine-learning algorithms trained on historical actions and past user responses, or data farmed from users by exposing them to various options and measuring responses. Although this disclosure describes calculating coefficients in a particular manner, this disclosure contemplates calculating coefficients in any suitable manner.

In particular embodiments, social-networking system 160 may calculate a coefficient based on a user's actions. Social-networking system 160 may monitor such actions on the online social network, on a third-party system 170, on other suitable systems, or any combination thereof. Any suitable type of user actions may be tracked or monitored. Typical user actions include viewing profile pages, creating or posting content, interacting with content, tagging or being tagged in images, joining groups, listing and confirming attendance at events, checking-in at locations, liking particular pages, creating pages, and performing other tasks that facilitate social action. In particular embodiments, social-networking system 160 may calculate a coefficient based on the user's actions with particular types of content. The content may be associated with the online social network, a third-party system 170, or another suitable system. The content may include users, profile pages, posts, news stories, headlines, instant messages, chat room conversations, emails, advertisements, pictures, video, music, other suitable objects, or any combination thereof. Social-networking system 160 may analyze a user's actions to determine whether one or more of the actions indicate an affinity for subject matter, content, other users, and so forth. As an example and not by way of limitation, if a user may make frequently posts content related to “coffee” or variants thereof, social-networking system 160 may determine the user has a high coefficient with respect to the concept “coffee”. Particular actions or types of actions may be assigned a higher weight and/or rating than other actions, which may affect the overall calculated coefficient. As an example and not by way of limitation, if a first user emails a second user, the weight or the rating for the action may be higher than if the first user simply views the user-profile page for the second user.

In particular embodiments, social-networking system 160 may calculate a coefficient based on the type of relationship between particular objects. Referencing the social graph 200, social-networking system 160 may analyze the number and/or type of edges 206 connecting particular user nodes 202 and concept nodes 204 when calculating a coefficient. As an example and not by way of limitation, user nodes 202 that are connected by a spouse-type edge (representing that the two users are married) may be assigned a higher coefficient than a user nodes 202 that are connected by a friend-type edge. In other words, depending upon the weights assigned to the actions and relationships for the particular user, the overall affinity may be determined to be higher for content about the user's spouse than for content about the user's friend. In particular embodiments, the relationships a user has with another object may affect the weights and/or the ratings of the user's actions with respect to calculating the coefficient for that object. As an example and not by way of limitation, if a user is tagged in first photo, but merely likes a second photo, social-networking system 160 may determine that the user has a higher coefficient with respect to the first photo than the second photo because having a tagged-in-type relationship with content may be assigned a higher weight and/or rating than having a like-type relationship with content. In particular embodiments, social-networking system 160 may calculate a coefficient for a first user based on the relationship one or more second users have with a particular object. In other words, the connections and coefficients other users have with an object may affect the first user's coefficient for the object. As an example and not by way of limitation, if a first user is connected to or has a high coefficient for one or more second users, and those second users are connected to or have a high coefficient for a particular object, social-networking system 160 may determine that the first user should also have a relatively high coefficient for the particular object. In particular embodiments, the coefficient may be based on the degree of separation between particular objects. The lower coefficient may represent the decreasing likelihood that the first user will share an interest in content objects of the user that is indirectly connected to the first user in the social graph 200. As an example and not by way of limitation, social-graph entities that are closer in the social graph 200 (i.e., fewer degrees of separation) may have a higher coefficient than entities that are further apart in the social graph 200.

In particular embodiments, social-networking system 160 may calculate a coefficient based on location information. Objects that are geographically closer to each other may be considered to be more related or of more interest to each other than more distant objects. In particular embodiments, the coefficient of a user towards a particular object may be based on the proximity of the object's location to a current location associated with the user (or the location of a client system 130 of the user). A first user may be more interested in other users or concepts that are closer to the first user. As an example and not by way of limitation, if a user is one mile from an airport and two miles from a gas station, social-networking system 160 may determine that the user has a higher coefficient for the airport than the gas station based on the proximity of the airport to the user.

In particular embodiments, social-networking system 160 may perform particular actions with respect to a user based on coefficient information. Coefficients may be used to predict whether a user will perform a particular action based on the user's interest in the action. A coefficient may be used when generating or presenting any type of objects to a user, such as advertisements, search results, news stories, media, messages, notifications, or other suitable objects. The coefficient may also be utilized to rank and order such objects, as appropriate. In this way, social-networking system 160 may provide information that is relevant to user's interests and current circumstances, increasing the likelihood that they will find such information of interest. In particular embodiments, social-networking system 160 may generate content based on coefficient information. Content objects may be provided or selected based on coefficients specific to a user. As an example and not by way of limitation, the coefficient may be used to generate media for the user, where the user may be presented with media for which the user has a high overall coefficient with respect to the media object. In particular embodiments, social-networking system 160 may generate expanded messaging indicators based on coefficient information. For example and not by way of limitation, a user may send and receive more messaging indicators or notifications from users who are more interesting to the user, e.g., from users or entities sharing a closer relationship with the user. A user may receive notifications describing actions in progress (e.g., a video message being recorded or a text message being composed) before receiving the actual message from other users having a low degree of separation and thus higher coefficient. In contrast, the social-networking system 160 may not send expanded messaging indicators to user with a lower coefficient.

In particular embodiments, social-networking system 160 may calculate a coefficient in response to a request for a coefficient from a particular system or process. To predict the likely actions a user may take (or may be the subject of) in a given situation, any process may request a calculated coefficient for a user. The request may also include a set of weights to use for various factors used to calculate the coefficient. This request may come from a process running on the online social network, from a third-party system 170 (e.g., via an API or other communication channel), or from another suitable system. In response to the request, social-networking system 160 may calculate the coefficient (or access the coefficient information if it has previously been calculated and stored). In particular embodiments, social-networking system 160 may measure an affinity with respect to a particular process. Different processes (both internal and external to the online social network) may request a coefficient for a particular object or set of objects. Social-networking system 160 may provide a measure of affinity that is relevant to the particular process that requested the measure of affinity. In this way, each process receives a measure of affinity that is tailored for the different context in which the process will use the measure of affinity.

In particular embodiments, one or more of the content objects of the online social network may be associated with a privacy setting. The privacy settings (or “access settings”) for an object may be stored in any suitable manner, such as, for example, in association with the object, in an index on an authorization server, in another suitable manner, or any combination thereof. A privacy setting of an object may specify how the object (or particular information associated with an object) can be accessed (e.g., viewed or shared) using the online social network. Where the privacy settings for an object allow a particular user to access that object, the object may be described as being “visible” with respect to that user. As an example and not by way of limitation, a user of the online social network may specify privacy settings for a user-profile page that identify a set of users that may access the work experience information on the user-profile page, thus excluding other users from accessing the information. In particular embodiments, the privacy settings may specify a “blocked list” of users that should not be allowed to access certain information associated with the object. In other words, the blocked list may specify one or more users or entities for which an object is not visible. As an example and not by way of limitation, a user may specify a set of users that may not access photos albums associated with the user, thus excluding those users from accessing the photo albums (while also possibly allowing certain users not within the set of users to access the photo albums). In particular embodiments, privacy settings may be associated with particular social-graph elements. Privacy settings of a social-graph element, such as a node or an edge, may specify how the social-graph element, information associated with the social-graph element, or content objects associated with the social-graph element can be accessed using the online social network. As an example and not by way of limitation, a particular concept node 204 corresponding to a particular photo may have a privacy setting specifying that the photo may only be accessed by users tagged in the photo and their friends. In particular embodiments, privacy settings may allow users to opt in or opt out of having their actions logged by social-networking system 160 or shared with other systems (e.g., third-party system 170). In particular embodiments, the privacy settings associated with an object may specify any suitable granularity of permitted access or denial of access. As an example and not by way of limitation, access or denial of access may be specified for particular users (e.g., only me, my roommates, and my boss), users within a particular degrees-of-separation (e.g., friends, or friends-of-friends), user groups (e.g., the gaming club, my family), user networks (e.g., employees of particular employers, students or alumni of particular university), all users (“public”), no users (“private”), users of third-party systems 170, particular applications (e.g., third-party applications, external websites), other suitable users or entities, or any combination thereof. Although this disclosure describes using particular privacy settings in a particular manner, this disclosure contemplates using any suitable privacy settings in any suitable manner.

In particular embodiments, one or more servers 162 may be authorization/privacy servers for enforcing privacy settings. In response to a request from a user (or other entity) for a particular object stored in a data store 164, social-networking system 160 may send a request to the data store 164 for the object. The request may identify the user associated with the request and may only be sent to the user (or a client system 130 of the user) if the authorization server determines that the user is authorized to access the object based on the privacy settings associated with the object. If the requesting user is not authorized to access the object, the authorization server may prevent the requested object from being retrieved from the data store 164, or may prevent the requested object from be sent to the user. In the search query context, an object may only be generated as a search result if the querying user is authorized to access the object. In other words, the object must have a visibility that is visible to the querying user. If the object has a visibility that is not visible to the user, the object may be excluded from the search results. Although this disclosure describes enforcing privacy settings in a particular manner, this disclosure contemplates enforcing privacy settings in any suitable manner.

In particular embodiments, expanded messaging indicators may be transmitted according to a user's privacy settings. Privacy settings may allow users to opt in or opt out of having their actions in progress logged by social-networking system 160 or shared with other systems (e.g., third-party system 170). Access or denial of access may be specified for particular users and for particular actions in progress. For example and not by way of limitation, a user may allow transmission and logging of data indicating a text message is being composed to roommates and family, but not to co-workers. In another example, a user may allow data indicating the time a message was read to co-workers but not to friends. Other privacy settings for expanded messaging indicators may be possible.

In particular embodiments, a user interface for social networking or messaging applications may include different elements, including, for example, a message input element, a message log (e.g., a historical log of messages transmitted by one or more users), or navigation elements (e.g., for navigation to other user interfaces or other applications). Through the user interface, users may transmit or receive various content items as messages, including texts, documents, video, audio, photos, gifs, other media, or a combination of media types. Prior to transmitting messages, a user may interact with content items on an associated client computing device by, for example, editing, recording, cropping, annotating, typing, drawing, or uploading content items. These interactions may occur in a message input element of a user interface, for example, or in other user interfaces for different applications. After receiving a message that includes one or more content items, a user may read, see, consume or interact with a specific content item. For example, a user may consume or interact with a content item when the user scrolls, opens up, views, plays listens to, selects, reviews, comments on, clicks on, or taps the content item. This disclosure contemplates any applicable means for a user to compose, consume or interact with a content item. The interactions may be part of messaging actions in progress but not yet completed or transmitted. Prior to transmitting a message by a first user, data associated with the actions in progress may be transmitted to a second user, and an indicator based on the data may be automatically presented to the second user. After transmitting the message, the first user may receive data relating to actions in progress by the second user as the second user consumes or interacts with the transmitted message. The first user may further be presented with other indicators describing other message actions in progress by the second user.

As described above, a user may interact with a computing device (e.g., a mobile device, a television, a personal computer, a smartphone, tablet computer, etc.) through an application currently running on the computing device (e.g., an application running in the foreground). The application may be, for example, a news feed application associated with a social-networking website, a game, a web browser, a telephony or text-messaging application, or any other suitable type of application. Within a user interface of the application currently used by the user, a messaging indicator may be automatically presented to the user. As an example, the messaging indicator may indicate to a first user that a second user is composing or consuming a message (e.g. from a second user on a social-networking website in which both participate, from an entity on the social-networking website, from a group on the social-networking website, from a concept node of the social-networking website, or from any other suitable source). The messaging indicator may, in particular embodiments, include some or all of the content of the message, such as a video still of a video being recorded, or a part of a text message that is being typed out by a second user. In other embodiments, the messaging indicator may be displayed without any content of the message as part of the indicator (e.g., an icon indicating that a message is being composed). As another example, the messaging indicator may indicate that the second user has received or read a message including, e.g., a telephone call, an email, a Short Message Service (SMS) message, an instant message, or any other type of message from any suitable source (whether on or off a social-networking website). In a chatting or messaging application, for example, a messaging indicator may further indicate that the second user is currently messaging a third user different from the first user. Any suitable type of information may be indicated by a messaging indicator including, for example, breaking news, trending topics, or actions associated with other users, entities, groups, or nodes of the social-networking website. For example, a messaging indicator may include an icon indicating an action associated with a second user of the social-networking website, such as the second user tagging the user in a post or the second user reading a post of the user in the social-networking website. As another example, a messaging indicator may include a title of a post being composed by a celebrity account that the user is following. Any suitable status or action of a user, entity, group, or node may be visually indicated by the messaging indicator corresponding to the user, entity, group, or node.

In particular embodiments, the messaging indicator may be automatically positioned or arranged in a particular area of the display of the user interface (e.g., in the top right of the display, or the middle of the display). The particular area of the display of the user interface may be a default area in the display or it may be associated with a position customized by the user. In other embodiments, the messaging indicator may be automatically positioned in the vicinity of a relevant message that was previously transmitted or received, or may be in a position where new messages typically appear. For example and not by way of limitation, for a news feed user interface that includes content by a multitude different users and entities of a social network, a user may receive messaging indicators in one default place. In another example, a first user may receive messaging indicators related to a particular post in the user's news feed, such as a messaging indicator that a second user is composing a reply to a status posted by a third user. In particular embodiments, the messaging indicator may be displayed in the vicinity of the third user's status, or the messaging indicator may be displayed where the second user's reply would appear when transmitted (e.g., at the end of a line of comments below the third user's status).

In particular embodiments, messaging indicators may be displayed automatically or substantially contemporaneously with an action in progress, e.g., 1 second, 0.3 seconds, or 500 milliseconds after an action in progress begins. In other embodiments, messaging indicators may be displayed a predetermined amount of time after an action in progress has started by a user. Data associated with an action in progress by a first or second user may be concurrently transmitted during the action in progress. Messaging indicators may be static during the action in progress (e.g., a video icon while a video message is being recorded), or the message indicator may change or be updated to reflect the status of an action in progress. For example and not by way of limitation, a video messaging indicator may continually reflect the length or size of the video message as it is being recorded. In another example, a typing indicator may be updated to reflect a current average typing rate of a user (e.g., a text indicator that initially describes 40 words per minute, but changes to 20 words per minute as a user pauses in typing). In another example of a chatting application, before a second user has read a message from a first user, the messaging indicator may inform the first user that the second user is chatting with other users in a separate window. When the second user returns to the first user, the messaging indicator may then indicate that the second user has read the first user's message.

In particular embodiments, a messaging indicator may disappear or be removed when a user performing an action in progress completes the action (e.g., a user completes composing a text by transmitting the text or a user fully reads a post by scrolling to the bottom) or when the user pauses the action for a predetermined amount of time (e.g., a user begins typing a message and stops typing without sending the message). For actions in progress prior to transmission of a message, a message indicator may be replaced by the transmitted message. For example and not by way of limitation, a first user may be presented with a messaging indicator for photo message currently being taken by a second user. When the second user completes taking the photo and transmits the photo to the first user, the messaging indicator may be replaced by the photo message. In another example, a first user may transmit a video message to a second user. When the second user views the video message, the first user may receive data associated with the second user viewing the video message and a message indicator may be presented to the first user (e.g., an icon indicating that the second user is viewing the video message. When the second user is finished viewing the video and no longer interacting with the video message, the messaging indicator may be removed from the user interface of the first user's client computing device.

In particular embodiments, a messaging indicator may function independently of an application running on the computing device. As an example, if the user is playing a game on the computing device, and a messaging indicator is displayed to the user (e.g., indicating that the user has a message from a second user on a social-networking website), the messaging indicator may be displayed independently from the game application (e.g., the messaging indicator may “float” on top of the display of the game). In another example, if the user is browsing among different user profiles on a social-networking website, the messaging indicator may be displayed independently from the content displayed in the user profiles (e.g., messaging indicator describing a post being composed by a nearby clothing store may be automatically displayed in a default location, such as a lower right corner of a screen). In particular embodiments, the messaging indicator may be displayed in a persistent manner, for example, so that the messaging indicator may continue to be displayed or updated even if the underlying application (e.g. a game) is paused, stopped, or exited. In particular embodiments, the messaging indicator may function in a manner that does not alter the activity of the application running on the computing device. For example, a user may continue to browse user profiles without interruption during the display of a messaging indicator. While a user is browsing user profiles, the messaging indicator (e.g., a viewing status of a video that the user previously sent to a second user) may be persistently updated to reflect a status of the action of viewing a video. (e.g., the timestamp of a video currently viewed by the second viewer).

As described above, a messaging indicator may be displayed and updated in a persistent manner. In particular embodiments, a messaging indicator may be displayed until the computing device either receives user input selecting the messaging indicator or user input dismissing the messaging indicator. By way of example, user input selecting the messaging indicator may include clicking on the messaging indicator (using, e.g., an input/output device such as a mouse or a track pad), tapping on the messaging indicator (using, e.g., a stylus or the user's finger), dragging the interactive element, or any other suitable touch or gesture (e.g. single tap, double tap, short press, long press, slide, swipe, flip, pinch open, or pinch close). In other embodiments, the user may, for example, provide input to dismiss the interactive element by pressing the messaging indicator and dragging it “off” (e.g. toward the edge of) the screen of the computing device. If the computing device receives user input to dismiss the messaging indicator, the interactive element may be removed from display to the user (e.g., removed from the screen display of the computing device).

In particular embodiments, selection of a messaging indicator may provide a way to navigate between different user interfaces, e.g., between a newsfeed user-interface and a messaging user-interface. As described above, the messaging indicator may be automatically presented in different locations, depending on a type of user interface in which the messaging indicator is presented or displayed (e.g., the messaging indicator may be presented in the vicinity of a previously transmitted message in a messaging user-interface, or presented in a default location in a browsing user-interface). In particular embodiments, the persistent manner of the messaging indicator may, for example, change the display location of the messaging indicator as the user interacts with a user interface or provides user input selecting the messaging indicator. For example, and not by way of limitation, a first user may be scrolling through a newsfeed user-interface and receive a messaging indicator indicating that a second user is recording a voice message to the first user in a chatting user-interface. In the newsfeed user-interface, the messaging indicator may be a voice message icon appearing in a default location, such as a lower right hand corner of the user interface. The first user may select the messaging indicator (e.g., by tapping on the indicator through a touchscreen), and the selection of the messaging indicator may allow navigation to a chatting user-interface between the first user and second user. The voice message icon may change location in the chatting user-interface to a location where new messages from the second user are displayed. As described above in particular embodiments, the voice message indicator may be persistently updated, for example, to include information on the status of the voice message being recorded. The updates on the status of the voice message being recorded (e.g., the length of the voice message) may, for example, be continually updated as the voice message indicator changes location in the newsfeed user-interface to the chatting user-interface.

In particular embodiments, a user may be presented with multiple messaging indicators that may indicate information to the user. As an example, two different messaging indicators may indicate that the two different messages are being composed or viewed, one from a first user and one from a second user on a social-networking website. As another example, a first messaging indicator presented to a user may indicate that a first user is composing a text message of more than 500 words and a second messaging indicator may indicate that a second user has clicked on a link posted by the user. Any suitable type of information may be indicated by one or more messaging indicators displayed to the user. In particular embodiments, the display and function of each of multiple messaging indicators are independent. For example, a first messaging indicator may be displayed, selected, dismissed, or removed, independent of a second messaging indicator. This disclosure contemplates any combination or suitable arrangement of messaging indicators in a display to a user of a computing device including, for example, a stack or pile, a vertical series, a horizontal series, or a fan-out display. As an example, the interactive elements may be displayed in a digest form (e.g., including recent actions in progress of other users) on a home screen of a computing device. In the example of a stack or pile display, the display may include a messaging indicator that the stack contains more than one messaging indicator from multiple users in the same group chat.

In particular embodiments, the user may control the specific types of information or events for which messaging indicators are displayed to the user. For example, the user may specify in the user's account settings with the social-networking system the types of information or events for which the user wishes to receive messaging indicators (e.g., actions in progress taken by friends, actions in progress taken by friends of friends, actions concerning friends, breaking news, etc.). Thereafter, whenever or as soon as an event or information item of the type selected by the user occurs, the social-networking system (e.g., through one of its servers) may send a notification of the event to the user's computing device, which then displays a messaging indicator to the user. The user may further control the specific types of media or message content for which the user received messaging indicators (e.g., actions in progress for text messages, actions in progress for video messages, actions in progress for status updates).

In particular embodiments, messaging indicators for an application (e.g., a messaging application or social-networking application) may be automatically presented to a user when the application is in the background, e.g., when the user is using a different application (e.g., streaming a video or reading an email), or when the user is not using a client computing device or the client computing device is idle. For example and not by way of limitation, a first user's client computing device may be currently running a streaming video application, and may be presented with a messaging indicator describing an action in progress by a second user in a social-networking application running in the background. The second user may be composing a post on the first user's public profile, and the messaging indicator may indicate, for example, how many words the second user has typed. In another example, the first user may transmit a private video recording to a second user through the social-networking application, and the first user may close the social-networking user interface associate with the application. When the second user begins playing the video recording, the first user may be presented with a messaging notification indicating that the second user is viewing the video message.

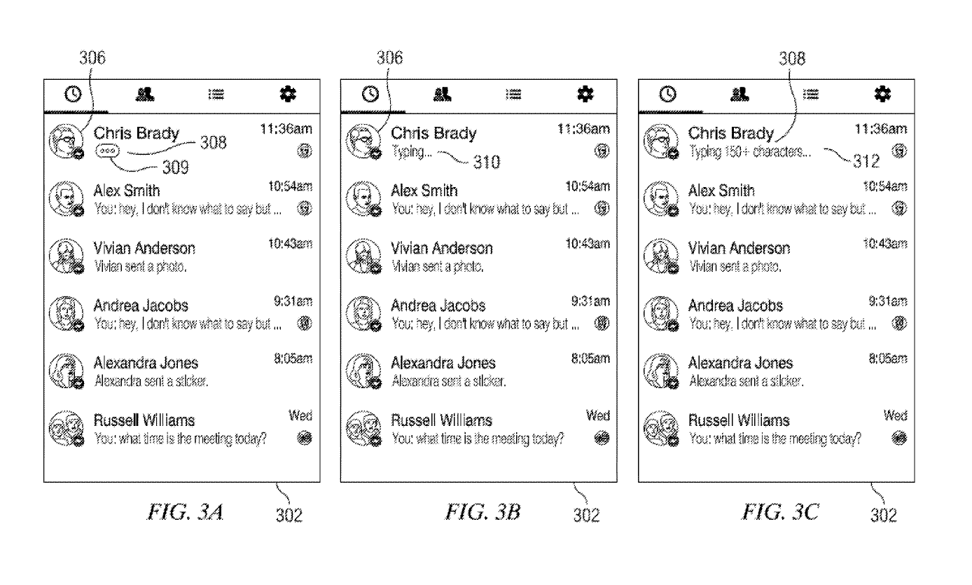

In particular embodiments, messaging indicators may be presented on a user interface while a chatting or messaging application is currently being used, or when an application is in the foreground. Indicators related to a particular message may be presented in the vicinity of the related message. FIGS. 3A-3C illustrate an example user interface with example indicators. In the example of FIGS. 3A-3C, and not by way of limitation, a messaging inbox user interface 302 for a first user may include a list of users that the first user has recently messaged. For each user listed, a most recent message exchanged with the first user may be presented below or in the vicinity of each user's name. The users may be listed based on the time stamp of the most recent message exchanged with the first user, for example. In particular embodiments, shown at FIG. 3A, a second user 306 may be in the process of composing a message to the first user, such as through typing a message or taking a photo. Data associated with the action in progress of composing a message on a client computing device of the second user 306 may be transmitted to the first user's client computing device (via a network or server, or both). The data may indicate that a message is being composed using the client computing device of the second user 306. As shown by FIG. 3A, a messaging indicator 308 may be automatically presented on the messaging inbox user interface 302 of the first user. The messaging indicator 308 may be an icon 309, as illustrated by FIG. 3A. In particular embodiments, the messaging indicator 308 may be presented or placed in a location where new messages typically appear.

With reference to FIG. 3B, a messaging indicator 308 may be a short text description 310. Data associated with the action of composing a message may include other information, such as the type of actions involved in composing the message, metadata about the actions, or status indicators about the user composing the message. As shown in FIG. 3B, the second user may be typing a message to the first user, and the short text description 310 may be presented on the messaging inbox user interface 302 to describe the action of typing. In another example of FIG. 3C, the short text description 310 may describe other metadata related to the action of typing, such as typing a message that is longer than 150 characters 312.

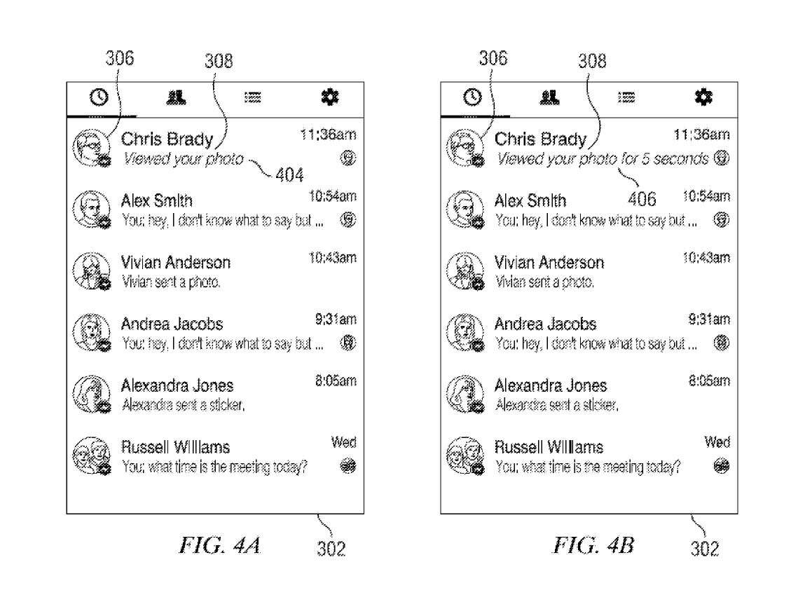

In particular embodiments, shown in FIGS. 4A and 4B, a second user 306 may be in the process of reading or consuming a message from the first user. FIGS. 4A and 4B illustrate an example of messaging indicators 308 for an example user interface, where the messaging indicators describe a second user's action or status while reading or interacting with message content from a first user. For example, as shown, the second user may receive a photo message transmitted by the first user. When the second user views the photo, data associated with the action of viewing the photo may be transmitted to the first user (e.g., via a network, server, or third party system). Data associated with the action of reading or interacting with the message content may include other information, such as the type of actions (e.g., viewing a photo) involved in reading the message, metadata about the actions (e.g., a length of time for viewing the photo, the number of times a photo is viewed), or status indicators about the user reading the message (e.g., the user reading the message has low battery). The messaging inbox user interface 302 may be automatically presented with a short text description 404 based on the data. For example, the short text description may indicate that the second user is viewing the photo. In another example of FIG. 4B, the short text description 406 may indicate that the second user viewed the photo for five seconds. An indicator may alternatively be an icon that relates to the action in progress. Other kinds of metadata associated with viewing or reading the message may also be described by the messaging indicator. In other embodiments, for example, a messaging indicator may describe a relevant status of the user. For example, prior to viewing the photo, the second user 306 may be messaging or chatting with a different user than the first user. Messaging indicator 308 may indicate that status with a short text description of “Chatting with someone” (not shown). Other kinds of status indicators may be possible.

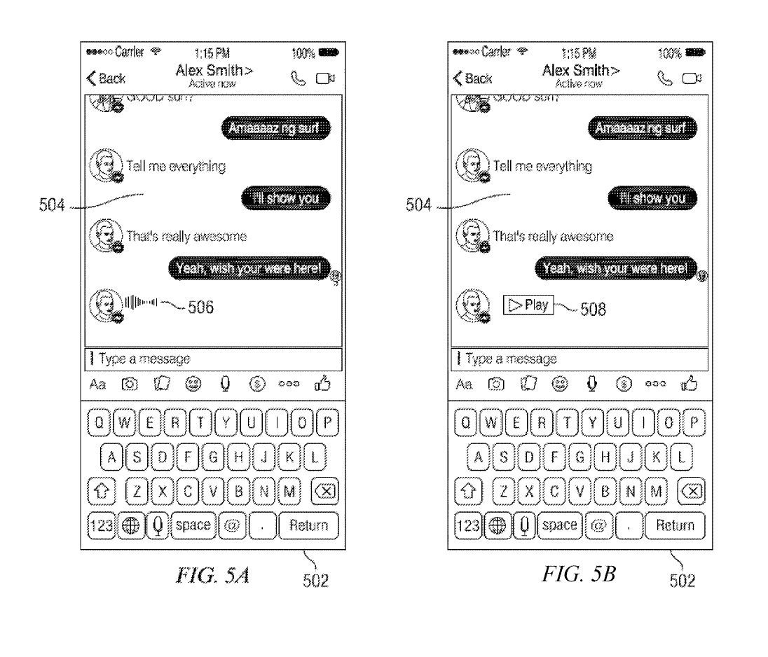

In particular embodiments, a message being composed may be a voice message. FIGS. 5A and 5B illustrate an example chatting or texting user interface 502 of a first user. The texting user interface 502 may include a log of messages 504 between the first user and a second user and a keyboard section for composing messages, for example. In other embodiments, more users may be involved in a texting session. As shown, messages from the first user may be presented on the right of the message log 504, and messages from the second user may be presented on the left of the message log 504. When the second user is composing a voice message to the first user, the texting user interface 502 of the first user may be automatically presented with a voice messaging icon 506, for example, which may resemble a recording waveform, as shown. The voice messaging icon 506 may be a different image in other embodiments. Prior to the first user's receipt of the voice message, the voice messaging icon 506 may be presented or placed in a location where a new message from the second user is typically shown. As shown in FIG. 5B, when the voice message is completed by the second user and transmitted to the first user, the completed voice message icon 508 may replace the voice message icon 506 in the location where new messages appear.

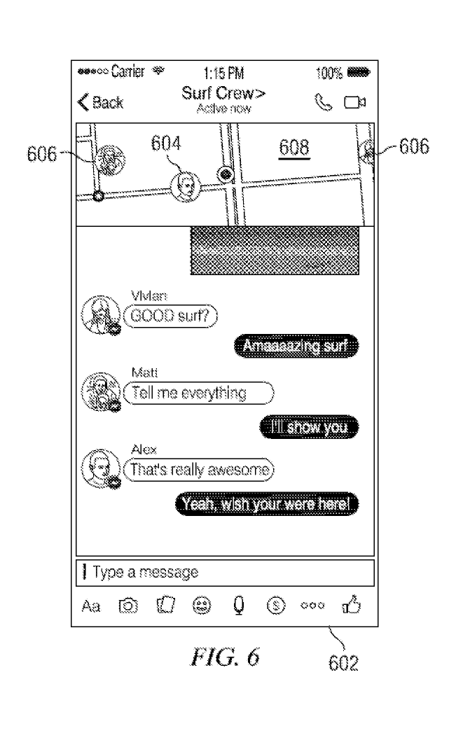

In particular embodiments, illustrated in FIG. 6, an example group texting user interface 602 may include multiple messaging indicators 606 describing actions in progress that relate to each user's status, such as a geolocation 604 of each user. As shown in FIG. 6, the messaging indicators 606 may be presented on a map 608 at the top of the group text, and each messaging indicator 606 may uniquely identify an associated user of the group text. In other embodiments, messaging indicators 606 may refer to or describe other kinds of statuses, such as an amount of battery left for each user or whether a user is connected through a Wi-Fi connection or a cellular data connection. The messaging indicators 606 may be presented in a specific section of the user interface (e.g., the map section 608 of the group text, as shown in FIG. 6), or they may be presented in the vicinity of the related user, for example.

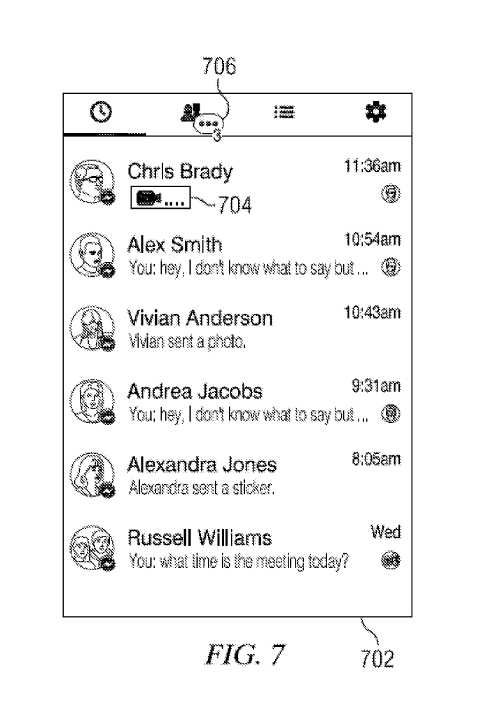

In particular embodiments, messaging indicators may indicate or describe user actions in progress in an application running in the foreground or background of a client computing device. FIG. 7 is an example messaging inbox user interface 702 for a messaging application, including example messaging indicators for a first user's client computing device. As shown, the messaging application may be a foreground application (e.g., the messaging application is currently running), and a second user may be in the process of creating a video message for the first user. The messaging inbox user interface 702 may automatically present a video messaging icon 704 indicating that a video recording is in progress on the second user's client computing device. In particular embodiments, other users may be composing messages for the first user in other applications running in the background of the client computing device, such as messages for a social networking application (e.g., a message being composed on the first user's public profile), E-mail application, or texting application. These applications, for example, may not be currently running or used by the first user, but the applications may maintain communication with a network in order to receive push notifications. The messaging inbox user interface 702 may automatically present a push notification 706 indicating that these messages are being composed. Alternatively, the push notifications may indicate that messages from the first user are being read or interacted with on a background application. In some embodiments, as shown in FIG. 7, the push notification 706 may provide a summary of multiple push notifications, e.g., that three messages are being composed or read on other users' client computing devices.

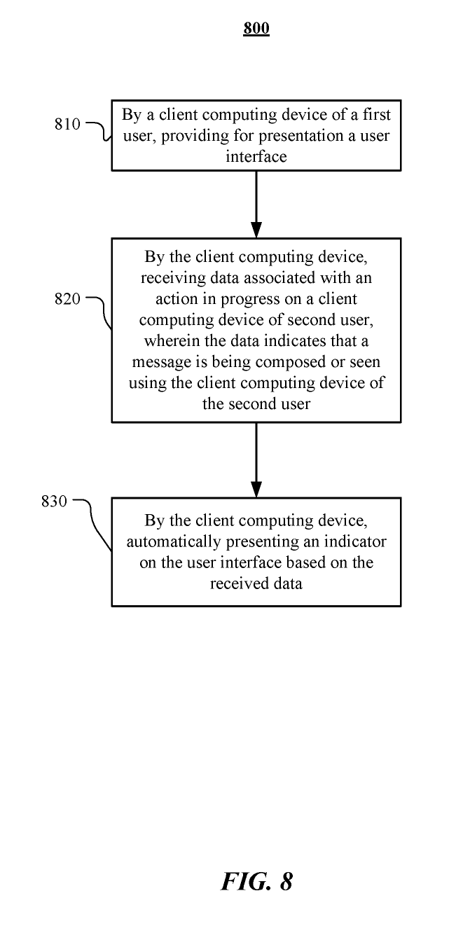

FIG. 8 illustrates an example method 800 for presenting expanded messaging indicators. The method may begin at step 810, where a client computing device of a first user may provide a user interface for presentation. The user interface may be for a software application running in the foreground or background of the client computing device. The software application may be, for example, a messaging application, message board, or social networking application. At step 820, the client computing device of the first user may receive data associated with an action in progress on a client computing device of second user, where the data indicates that a message is being composed or seen using the client computing device of the second user. The action in progress may any one of, for example, typing a message, reading a message sent by the first user, taking a photo, or creating a video or audio message. At step 830, the client computing device may automatically present an indicator on the user interface based on the received data. Particular embodiments may repeat one or more steps of the method of FIG. 8, where appropriate. Although this disclosure describes and illustrates particular steps of the method of FIG. 8 as occurring in a particular order, this disclosure contemplates any suitable steps of the method of FIG. 8 occurring in any suitable order. Moreover, although this disclosure describes and illustrates an example method for presenting expanded messaging indicators including the particular steps of the method of FIG. 8, this disclosure contemplates any suitable method for presenting expanded messaging indicators including any suitable steps, which may include all, some, or none of the steps of the method of FIG. 8, where appropriate. Furthermore, although this disclosure describes and illustrates particular components, devices, or systems carrying out particular steps of the method of FIG. 8, this disclosure contemplates any suitable combination of any suitable components, devices, or systems carrying out any suitable steps of the method of FIG. 8.

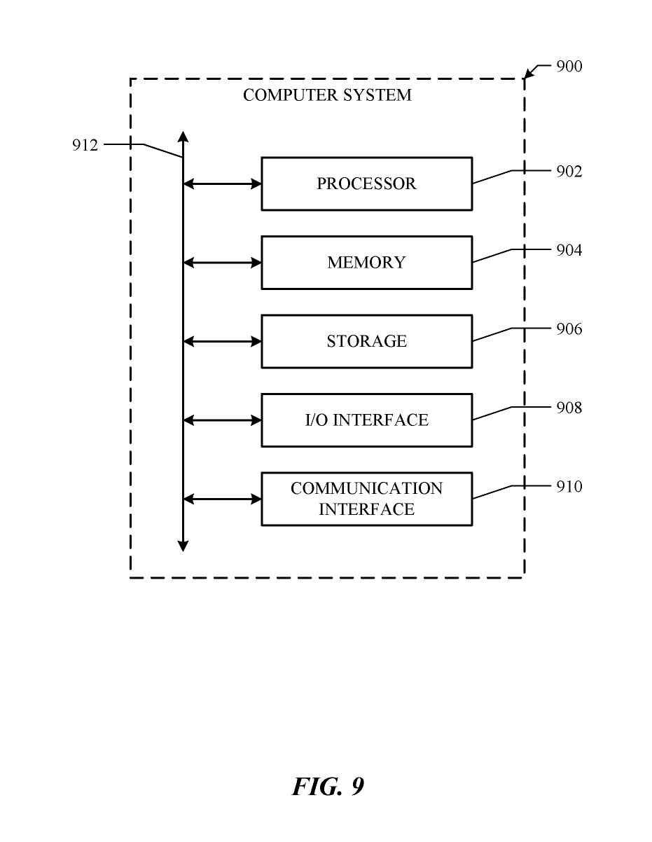

FIG. 9 illustrates an example computer system 900. In particular embodiments, one or more computer systems 900 perform one or more steps of one or more methods described or illustrated herein. In particular embodiments, one or more computer systems 900 provide functionality described or illustrated herein. In particular embodiments, software running on one or more computer systems 900 performs one or more steps of one or more methods described or illustrated herein or provides functionality described or illustrated herein. Particular embodiments include one or more portions of one or more computer systems 900. Herein, reference to a computer system may encompass a computing device, and vice versa, where appropriate. Moreover, reference to a computer system may encompass one or more computer systems, where appropriate.

This disclosure contemplates any suitable number of computer systems 900. This disclosure contemplates computer system 900 taking any suitable physical form. As example and not by way of limitation, computer system 900 may be an embedded computer system, a system-on-chip (SOC), a single-board computer system (SBC) (such as, for example, a computer-on-module (COM) or system-on-module (SOM)), a desktop computer system, a laptop or notebook computer system, an interactive kiosk, a mainframe, a mesh of computer systems, a mobile telephone, a personal digital assistant (PDA), a server, a tablet computer system, an augmented/virtual reality device, or a combination of two or more of these. Where appropriate, computer system 900 may include one or more computer systems 900; be unitary or distributed; span multiple locations; span multiple machines; span multiple data centers; or reside in a cloud, which may include one or more cloud components in one or more networks. Where appropriate, one or more computer systems 900 may perform without substantial spatial or temporal limitation one or more steps of one or more methods described or illustrated herein. As an example and not by way of limitation, one or more computer systems 900 may perform in real time or in batch mode one or more steps of one or more methods described or illustrated herein. One or more computer systems 900 may perform at different times or at different locations one or more steps of one or more methods described or illustrated herein, where appropriate.

In particular embodiments, computer system 900 includes a processor 902, memory 904, storage 906, an input/output (I/O) interface 908, a communication interface 910, and a bus 912. Although this disclosure describes and illustrates a particular computer system having a particular number of particular components in a particular arrangement, this disclosure contemplates any suitable computer system having any suitable number of any suitable components in any suitable arrangement.

In particular embodiments, processor 902 includes hardware for executing instructions, such as those making up a computer program. As an example and not by way of limitation, to execute instructions, processor 902 may retrieve (or fetch) the instructions from an internal register, an internal cache, memory 904, or storage 906; decode and execute them; and then write one or more results to an internal register, an internal cache, memory 904, or storage 906. In particular embodiments, processor 902 may include one or more internal caches for data, instructions, or addresses. This disclosure contemplates processor 902 including any suitable number of any suitable internal caches, where appropriate. As an example and not by way of limitation, processor 902 may include one or more instruction caches, one or more data caches, and one or more translation lookaside buffers (TLBs). Instructions in the instruction caches may be copies of instructions in memory 904 or storage 906, and the instruction caches may speed up retrieval of those instructions by processor 902. Data in the data caches may be copies of data in memory 904 or storage 906 for instructions executing at processor 902 to operate on; the results of previous instructions executed at processor 902 for access by subsequent instructions executing at processor 902 or for writing to memory 904 or storage 906; or other suitable data. The data caches may speed up read or write operations by processor 902. The TLBs may speed up virtual-address translation for processor 902. In particular embodiments, processor 902 may include one or more internal registers for data, instructions, or addresses. This disclosure contemplates processor 902 including any suitable number of any suitable internal registers, where appropriate. Where appropriate, processor 902 may include one or more arithmetic logic units (ALUs); be a multi-core processor; or include one or more processors 902. Although this disclosure describes and illustrates a particular processor, this disclosure contemplates any suitable processor.

In particular embodiments, memory 904 includes main memory for storing instructions for processor 902 to execute or data for processor 902 to operate on. As an example and not by way of limitation, computer system 900 may load instructions from storage 906 or another source (such as, for example, another computer system 900) to memory 904. Processor 902 may then load the instructions from memory 904 to an internal register or internal cache. To execute the instructions, processor 902 may retrieve the instructions from the internal register or internal cache and decode them. During or after execution of the instructions, processor 902 may write one or more results (which may be intermediate or final results) to the internal register or internal cache. Processor 902 may then write one or more of those results to memory 904. In particular embodiments, processor 902 executes only instructions in one or more internal registers or internal caches or in memory 904 (as opposed to storage 906 or elsewhere) and operates only on data in one or more internal registers or internal caches or in memory 904 (as opposed to storage 906 or elsewhere). One or more memory buses (which may each include an address bus and a data bus) may couple processor 902 to memory 904. Bus 912 may include one or more memory buses, as described below. In particular embodiments, one or more memory management units (MMUs) reside between processor 902 and memory 904 and facilitate accesses to memory 904 requested by processor 902. In particular embodiments, memory 904 includes random access memory (RAM). This RAM may be volatile memory, where appropriate Where appropriate, this RAM may be dynamic RAM (DRAM) or static RAM (SRAM). Moreover, where appropriate, this RAM may be single-ported or multi-ported RAM. This disclosure contemplates any suitable RAM. Memory 904 may include one or more memories 904, where appropriate. Although this disclosure describes and illustrates particular memory, this disclosure contemplates any suitable memory.

In particular embodiments, storage 906 includes mass storage for data or instructions. As an example and not by way of limitation, storage 906 may include a hard disk drive (HDD), a floppy disk drive, flash memory, an optical disc, a magneto-optical disc, magnetic tape, or a Universal Serial Bus (USB) drive or a combination of two or more of these. Storage 906 may include removable or non-removable (or fixed) media, where appropriate. Storage 906 may be internal or external to computer system 900, where appropriate. In particular embodiments, storage 906 is non-volatile, solid-state memory. In particular embodiments, storage 906 includes read-only memory (ROM). Where appropriate, this ROM may be mask-programmed ROM, programmable ROM (PROM), erasable PROM (EPROM), electrically erasable PROM (EEPROM), electrically alterable ROM (EAROM), or flash memory or a combination of two or more of these. This disclosure contemplates mass storage 906 taking any suitable physical form. Storage 906 may include one or more storage control units facilitating communication between processor 902 and storage 906, where appropriate. Where appropriate, storage 906 may include one or more storages 906. Although this disclosure describes and illustrates particular storage, this disclosure contemplates any suitable storage.

In particular embodiments, I/O interface 908 includes hardware, software, or both, providing one or more interfaces for communication between computer system 900 and one or more I/O devices. Computer system 900 may include one or more of these I/O devices, where appropriate. One or more of these I/O devices may enable communication between a person and computer system 900. As an example and not by way of limitation, an I/O device may include a keyboard, keypad, microphone, monitor, mouse, printer, scanner, speaker, still camera, stylus, tablet, touch screen, trackball, video camera, another suitable I/O device or a combination of two or more of these. An I/O device may include one or more sensors. This disclosure contemplates any suitable I/O devices and any suitable I/O interfaces 908 for them. Where appropriate, I/O interface 908 may include one or more device or software drivers enabling processor 902 to drive one or more of these I/O devices. I/O interface 908 may include one or more I/O interfaces 908, where appropriate. Although this disclosure describes and illustrates a particular I/O interface, this disclosure contemplates any suitable I/O interface.

In particular embodiments, communication interface 910 includes hardware, software, or both providing one or more interfaces for communication (such as, for example, packet-based communication) between computer system 900 and one or more other computer systems 900 or one or more networks. As an example and not by way of limitation, communication interface 910 may include a network interface controller (NIC) or network adapter for communicating with an Ethernet or other wire-based network or a wireless NIC (WNIC) or wireless adapter for communicating with a wireless network, such as a WI-FI network. This disclosure contemplates any suitable network and any suitable communication interface 910 for it. As an example and not by way of limitation, computer system 900 may communicate with an ad hoc network, a personal area network (PAN), a local area network (LAN), a wide area network (WAN), a metropolitan area network (MAN), or one or more portions of the Internet or a combination of two or more of these. One or more portions of one or more of these networks may be wired or wireless. As an example, computer system 900 may communicate with a wireless PAN (WPAN) (such as, for example, a BLUETOOTH WPAN), a WI-FI network, a WI-MAX network, a cellular telephone network (such as, for example, a Global System for Mobile Communications (GSM) network), or other suitable wireless network or a combination of two or more of these. Computer system 900 may include any suitable communication interface 910 for any of these networks, where appropriate. Communication interface 910 may include one or more communication interfaces 910, where appropriate. Although this disclosure describes and illustrates a particular communication interface, this disclosure contemplates any suitable communication interface.

In particular embodiments, bus 912 includes hardware, software, or both coupling components of computer system 900 to each other. As an example and not by way of limitation, bus 912 may include an Accelerated Graphics Port (AGP) or other graphics bus, an Enhanced Industry Standard Architecture (EISA) bus, a front-side bus (FSB), a HYPERTRANSPORT (HT) interconnect, an Industry Standard Architecture (ISA) bus, an INFINIBAND interconnect, a low-pin-count (LPC) bus, a memory bus, a Micro Channel Architecture (MCA) bus, a Peripheral Component Interconnect (PCI) bus, a PCI-Express (PCIe) bus, a serial advanced technology attachment (SATA) bus, a Video Electronics Standards Association local (VLB) bus, or another suitable bus or a combination of two or more of these. Bus 912 may include one or more buses 912, where appropriate. Although this disclosure describes and illustrates a particular bus, this disclosure contemplates any suitable bus or interconnect.

Herein, a computer-readable non-transitory storage medium or media may include one or more semiconductor-based or other integrated circuits (ICs) (such, as for example, field-programmable gate arrays (FPGAs) or application-specific ICs (ASICs)), hard disk drives (HDDs), hybrid hard drives (HHDs), optical discs, optical disc drives (ODDs), magneto-optical discs, magneto-optical drives, floppy diskettes, floppy disk drives (FDDs), magnetic tapes, solid-state drives (SSDs), RAM-drives, SECURE DIGITAL cards or drives, any other suitable computer-readable non-transitory storage media, or any suitable combination of two or more of these, where appropriate. A computer-readable non-transitory storage medium may be volatile, non-volatile, or a combination of volatile and non-volatile, where appropriate.

Herein, “or” is inclusive and not exclusive, unless expressly indicated otherwise or indicated otherwise by context. Therefore, herein, “A or B” means “A, B, or both,” unless expressly indicated otherwise or indicated otherwise by context. Moreover, “and” is both joint and several, unless expressly indicated otherwise or indicated otherwise by context. Therefore, herein, “A and B” means “A and B, jointly or severally,” unless expressly indicated otherwise or indicated otherwise by context.

The scope of this disclosure encompasses all changes, substitutions, variations, alterations, and modifications to the example embodiments described or illustrated herein that a person having ordinary skill in the art would comprehend. The scope of this disclosure is not limited to the example embodiments described or illustrated herein. Moreover, although this disclosure describes and illustrates respective embodiments herein as including particular components, elements, feature, functions, operations, or steps, any of these embodiments may include any combination or permutation of any of the components, elements, features, functions, operations, or steps described or illustrated anywhere herein that a person having ordinary skill in the art would comprehend. Furthermore, reference in the appended claims to an apparatus or system or a component of an apparatus or system being adapted to, arranged to, capable of, configured to, enabled to, operable to, or operative to perform a particular function encompasses that apparatus, system, component, whether or not it or that particular function is activated, turned on, or unlocked, as long as that apparatus, system, or component is so adapted, arranged, capable, configured, enabled, operable, or operative. Additionally, although this disclosure describes or illustrates particular embodiments as providing particular advantages, particular embodiments may provide none, some, or all of these advantages.

What is claimed is:

1. A method, comprising:
by a client computing device of a first user, providing for presentation a user interface;
by the client computing device, receiving data associated with an action in progress on a client computing device of second user, wherein the data indicates that a message is being composed or seen using the client computing device of the second user; and
by the client computing device, automatically presenting an indicator on the user interface based on the received data.

2. The method of claim 1, wherein the user interface is for a messaging application, message board, or social network.

3. The method of claim 1, wherein the action in progress is any one of: typing a message, reading a message sent by the first user, taking a photo, or creating a video or audio message.

4. The method of claim 1, comprising receiving, by the client computing device, the message from the second user after automatically presenting an indicator.

5. The method of claim 1, comprising receiving the data after sending, by the client computing device, the message from the first user.

6. The method of claim 1, wherein the indicator is an icon or text description of the action in progress.

7. The method of claim 1, wherein the presented user interface is of an application on the client computing device that is running in the foreground.

8. The method of claim 1, wherein the indicator is a push notification.

9. The method of claim 1, wherein the received data is based on a type of relationship between the first and second user.

10. The method of claim 1, wherein the received data is based on a privacy setting set by the second user.

11. One or more computer-readable non-transitory storage media embodying software that is operable when executed to:
provide a user interface for presentation at a client computing device of a first user;
receive data associated with an action in progress on a client computing device of a second user, wherein the data indicates that a message is being composed or seen using the client computing device of the second user; and
automatically present an indicator on the user interface based on the received data.

12. The media of claim 11, wherein the user interface is for a messaging application, message board, or social network.

13. The media of claim 11, wherein the action in progress is any one of: typing a message, reading a message sent by the first user, taking a photo, or creating a video or audio message.

14. The media of claim 11, wherein the software is operable when executed to receive the message from the second user after automatically presenting an indicator.

15. The media of claim 11, wherein the indicator is an icon or text description of the action in progress.

16. A system comprising:
a first client computing device configured to provide a user interface for presentation to a first user;
a server configured to receive data associated with an action in progress on a client computing device of a second user, wherein the data indicates that a message is being composed or seen using the client computing device of the second user;
wherein the first client computing device is further configured to automatically present an indicator on the user interface based on data received by the server.

17. The system of claim 16, wherein the action in progress is any one of: typing a message, reading a message sent by the first user, taking a photo, or creating a video or audio message.

18. The system of claim 16, wherein the indicator is an icon or text description of the action in progress.

19. The system of claim 16, wherein the indicator is a push notification.

20. The system of claim 16, wherein the first client computing device is configured to receive the message from the second user after automatically presenting an indicator.
